(19) United States
(12) Patent Application Publication
(10) Pub. No.: US 2023/0028884 A1
(43) Pub. Date: Jan. 26, 2023

(54) FLEA AND TICK COLLAR

(71) Applicant: Wellmark International, Schaumburg, IL (US)

(72) Inventors: Min XIE, Dallas, TX (US); Hon NGUYEN, Dallas, TX (US)

(73) Assignee: Wellmark International, Schaumburg, IL (US)

(21) Appl. No.: 17/866,955

(22) Filed: Jul. 18, 2022

Related U.S. Application Data
(63) Continuation of application No. PCT/US22/36997, filed on Jul. 13, 2022.
(60) Provisional application No. 63/222,856, filed on Jul. 16, 2021.

(51) Int. Cl. A01N 43/40; A01K 27/00; A01N 43/08; A01N 37/06

(52) U.S. Cl. CPC A01N 43/40; A01K 27/007; A01N 43/08; A01N 37/06

(57) ABSTRACT

The disclosure provides an insecticide formulation, comprising: i) a neonicotinoid optionally together with a pyrethroid; ii) an insect growth regulator; and iii) a filling agent together with a plasticizer.

### CROSS-REFERENCE TO RELATED APPLICATIONS

The present application is a continuation of International Application No. PCT/US22/36997, filed on Jul. 13, 2022, which claims priority to U.S. Provisional Application No. 63/222,856, filed Jul. 16, 2021, the disclosures of which are hereby incorporated by reference in their entireties for all purposes.

### BACKGROUND

The present disclosure relates generally to animal care and accessories, and in particular, to a flea and tick collar. The infestation of domestic animals with blood-feeding parasites, such as with ticks and fleas, is a considerable health and nuisance problem. Keeping a companion animal free from fleas, ticks and similar parasites can be very challenging. Companion animals become infested with such parasites and owners must apply insecticides regularly in order to eradicate the parasites.

Fleas are wingless insects with highly developed legs suitable for jumping. They are blood-sucking ectoparasites of mammals or birds. The some 2000 species belong to the order Siphonaptera and include for example, Ctenocephalides spp., Echidnophaga spp., Ceratophyllus spp., and Pulex spp. Ctenocephalides is the genus of flea most commonly found on dogs. Fleas are not host specific; the same species of flea may be found on dogs, cats, rabbits, and humans, which obviously create difficulty in controlling fleas in an infested household.

Fleas live in the fur of animals. The cat flea, which is the most common, is capable of reproducing on both cats and dogs. It can also attack humans and other pets.

Flea bites cause itching in both animals and humans. The flea saliva can also lead to immediate or delayed allergic reactions. Flea infestations can therefore represent a considerable and challenging problem for both animals and humans and make it necessary to have suitable treatments.

Attempts to improve and simplify the control of fleas and ticks have previously involved providing a device, such as a collar comprising an insecticide, to be worn by the animal. For domesticated pets such as dogs and cats, insecticidal collars have been used which comprise a solid matrix material impregnated with an insecticidal composition that is released from the collar and spread when the collar rubs against the animal's coat.

Flea and tick collars are generally effective for a limited or a temporary time period. In view of the above, what is needed in the art is an effective flea and tick collar with greater duration of improved efficacy. The present disclosure satisfies these and offers other advantages as well.

### BRIEF SUMMARY

The present disclosure provides a formulation, device or a pet collar useful for repelling and killing arthropod pests or ectoparasites. As such, in one embodiment, the disclosure provides an insecticide formulation, the formulation comprising:

i) a neonicotinoid optionally together with a pyrethroid;

ii) an insect growth regulator; and

iii) a filling agent together with a plasticizer.

In certain instances, the formulation is molded into an article of manufacture such as a collar.

In another embodiment, the present disclosure provides a method for controlling insects on an animal such as a companion animal (e.g., dog, cat and the like), the method comprising: contacting the companion animal with an insecticide formulation comprising:

i) a neonicotinoid optionally together with a pyrethroid;

ii) an insect growth regulator; and

iii) a filling agent together with a plasticizer, to thereby treat the companion animal.

In certain instances, the formulation is molded into an article of manufacture such as a collar.

In yet another embodiment, the present disclosure provides a formulation, device or a pet collar for use in repelling and killing arthropod pests or ectoparasites. As such, in one embodiment, the disclosure provides an insecticide formulation, the formulation, device or a pet collar for use in repelling and killing arthropod pests or ectoparasites, comprising:

i) a neonicotinoid optionally together with a pyrethroid;

ii) an insect growth regulator; and

iii) a filling agent together with a plasticizer.

These and other aspects, object and embodiments will become more apparent when read with the detailed description and figures which follow.

### BRIEF DESCRIPTION OF THE DRAWINGS

FIG. 1 shows the efficacy of certain embodiments of the disclosure.

FIG. 2 shows the efficacy of certain embodiments of the disclosure.

### DETAILED DESCRIPTION

### I. Embodiments

The present disclosure provides compositions, articles of manufacture, formulations and methods for controlling fleas and/or ticks. The formulations are especially useful for companion animals, such as dogs and cats. Advantageously, the formulations, articles of manufacture, and methods control both fleas and ticks while being safe for pets and humans. The formulations can be molded into an article of manufacture such as a collar. The disclosed articles of manufacture (e.g., collars) minimize the need for repeated application by maintaining their effectiveness over a period of time beyond the initial application for flea and tick control.

In certain instances, the formulation is molded into article of manufacture, which can be a device or a pet collar useful for repelling and/or killing arthropod pests. As such, in one embodiment, the disclosure provides an insecticide formulation, the formulation comprising:

i) a neonicotinoid optionally together with a pyrethroid;

ii) an insect growth regulator; and

iii) a filling agent together with a plasticizer.

In certain instances, the formulation is molded into article of manufacture, which can be a pet collar. The disclosed pet collar can be a wearable device by the companion animal. The formulation contains one or more insecticides, which insecticide(s) repel or kill insects such as an arthropod on pets.

In certain aspects, the formulation comprises a neonicotinoid selected from acetamiprid, clothianidin, dinotefuran, imidacloprid, nitenpyram, thiocloprid, thiamethoxam and mixtures thereof. Neonicotinoids are a class of neuro-active insecticides, which are chemically similar to nicotine. The neonicotinoid family of insecticides includes acetamiprid, clothianidin, imidacloprid, nitenpyram, nithiazine, thiacloprid and thiamethoxam. In certain aspects, the neonicotinoid of the formulation is acetamiprid, dinotefuran or a combination thereof.

In certain aspects, the neonicotinoid is present in the formulation at about 5% to about 15% w/w, such as about 5%, 6%, 7%, 8%, 9%, 10%, 11%, 12%, 13%, 14%, and/or 15%. In certain instances, the neonicotinoid is present in the formulation at about 8% w/w to about 12% w/w, such as 9.0% w/w to about 11.0% w/w.

In certain aspects, the formulation optionally comprises a pyrethroid or a derivative thereof. In certain aspects, the pyrethroid is selected form the group of allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, lambda-cyhalothrin, metofluthrin, permethrin, prallethrin, pyrethrin I, cinerin I, jasmolin I, pyrethrin II, cinerin II, jasmolin II, resmethrin, silafluofen, sumithrin, tau-fluvalinate, tefluthrin, tetramethrin, tralomethrin, and transfluthrin. In certain aspects, the pyrethroid of the formulation is deltamethrin.

In certain aspects, the pyrethroid is present in the formulation at about 1% to about 10% w/w, such as about 1%, 2%, 3%, 4%, 5%, 6%, 7%, 8%, 9%, and/or 10%. In certain instances, the pyrethroid is present at about 3% to about 6% w/w.

In certain aspects, the formulation comprises an insect growth regulator (IGR). Suitable IGRs for use in the present disclosure include, without limitation, chitin synthesis inhibitors, juvenile hormone mimics, juvenile hormones, molting hormone agonists, molting hormones, molting inhibitors, precocenes, unclassified insect growth regulators, and mixtures thereof. IGRs include, for example, methoprene, hydroprene, kinoprene, fenoxycarb, pyriproxifen, cyromazine, diflubenzuron, novaluron, and mixtures thereof. In one instance, the IGR is methoprene such as S-methoprene.

In certain aspects, the IGR is present in the formulation at about 0.1% to about 10% w/w, such as about 0.1% to about 5% w/w. For example, the IGR can be present at 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, and/or 5%. In certain instances, the IGR is present at 0.5% to about 5% w/w.

In certain aspects, a combination of active ingredients is useful for the purpose of improving the efficiency of each active agent taken individually and/or broadening the spectrum of action of the formulation. For example, the disclosed formulations are equally effective against tick infestations and/or flea infestations and are useful for the purpose of reducing the doses of the individual active agents in order to combat, for example, the possible negative effects thereof on the environment, or to combat resistance phenomena, while at the same time maintaining satisfactory insecticidal efficiency and efficacy.

In certain aspects, the insecticide(s) act as an adulticide, an insect growth regulator, a larvacide, an ovidicide or a combination thereof. Certain combinations of insecticides are synergistic against fleas, ticks or combinations thereof. For example, certain combinations of adulticides and IGRs are synergistic against immature fleas.

In certain aspects, the formulation further comprises a lubricant. For example, the lubricant can be selected from the group of a paraffin oil, a polyethylene wax, a long chain fatty alcohol, a distearyl ketone, a long chain fatty acid, metal salts thereof and esters thereof.

In certain aspects, the lubricant is present at a concentration of 0.1% w/w to about 3% w/w such as 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, and/or 3% w/w.

In certain aspects, the formulation further comprises a preservative. In certain aspects, the preservative is selected from the group of 2-(2H-Benzotriazol-2-yl)-4-methylphenol, 2-Ethylhexyl 2-cyano-3,3-diphenylacrylate, α-tocopherol, bis(1,2,2,6,6-pentamethyl-4-piperidinyl) decanedioate, bis-(2,4-ditertbutylphenyl)-pentaerythrityl-diphosphite, bisphenol A, butylated hydroxytoluene, butylated hydroxyanisole, dilauryl thiopropionate, distearyl thiodipropionate, dioctadecyl disulfide, epoxidized soybean oil, epoxidized linseed oil, epozidized tall oil esters, pentaerythritol tetrakis(3,5-di-tert-butyl-4-hydroxyhydrocinnamate), zinc 2-pyridinethiol-1-oxide, tetrakis-(2,4-ditertbutylphenyl)-4,4′-diphenylylenediphosphonite, distearyl-petaerythrityl-diphosphite, tris-(nonylphenyl)-phosphite, and tris-(2,4-ditertbutylphenyl)-phosphite.

In certain aspects, the preservative is present at a concentration of 0.1% w/w to about 8% w/w such about 1% to about 8% w/w, such as about 1%, 2%, 3%, 4%, 5%, 6%, 7% and/or 8% w/w.

In certain aspects, the present disclosure provides stabilizers, preservative and/or antioxidants which can be sulphites or metabisulphites, organic acids, such as citric acid, ascorbic acid, malic acid; phenols, butylhydroxytoluene (BHT), butylhydroxyanisole, vitamin (tocopherols), and the like.

The present disclosure provides formulations, articles of manufacture, and methods for controlling fleas and/or ticks that are environmentally compatible and user-friendly due to the very low level of toxicity.

In one embodiment, the present disclosure provides a method for controlling insects on an animal, the method comprising:

contacting the companion animal with an insecticide composition comprising:

i) a neonicotinoid optionally together with a pyrethroid;

ii) an insect growth regulator; and

iii) a filling agent together with a plasticizer, to thereby treat the companion animal.

The methods of the disclosure are suitable for the control of parasitic insects that occur in the keeping of companion animals and breeding of animals in pets, useful animals, as well as in zoo animals, laboratory animals, test animals and hobby animals. They are effective against parasitic pests selected from the group of the ectoparasites, such as insects and mites (e.g. lice, ticks, flies, mites, fleas, sand flies, and the like), in particular including, for example: from the order of the Anoplura, for example, Haematopinus spp., Linognathus spp., Solenopotes spp., Pediculus spp., Pthirus spp.; from the order of the Mallophaga, for example, Trimenopon spp., Menopon spp., Eomenacanthus spp., Menacanthus spp., Trichodectes spp., Felicola spp., Damalinea spp., Bovicola spp; from the order of the Diptera, suborder Brachycera, for example, Chrysops spp., Tabanus spp., Musca spp., Hydrotaea spp., Muscina spp., Haematobosca spp., Haematobia spp., Stomoxys spp., Fannia spp., Glossina spp., Lucilia spp., Calliphora spp., Auchmeromyia spp., Cordylobia spp., Cochliomyia spp., Crysomyia spp., Sarcophaga spp., Wohlfartia spp., Gasterophilus spp., Oesteromyia spp., Oedemagena spp., Hypoderma spp., Oestrus spp., Rhinoestrus spp., Melophagus spp., Hippobosca spp;

from the order of the Diptera, suborder Nematocera, for example, Culex spp., Aedes spp., Anopheles spp., Culicoides spp., Phlebotomus spp., Simulium spp.;

from the order of the Siphonaptera, for example, Ctenocephalides spp., Echidnophaga spp., Ceratophyllus spp., Pulex spp.;

from the order of the Metastigmata, for example, Hyalomma spp., Rhipicephalus spp., Boophilus spp., Amblyomma spp., Haemaphysalis spp., Dermacentor spp., Ixodes spp., Argas spp., Ornithodorus spp., Otobius spp.;

from the order of the Mesostigmata, for example Dermanyssus spp., Ornithonyssus spp., Pneumonyssus spp.;

from the order of the Prostigmata, for example Cheyletiella spp., Psorergates spp., Myobia spp., Demodex spp., Neotrombicula spp.;

from the order of the Astigmata, for example, Acarus spp., Myocoptes spp., Psoroptes spp., Chorioptes spp., Otodectes spp., Sarcoptes spp., Notoedres spp., Knemidocoptes spp., Neoknemidocoptes spp., Cytodites spp., Laminosioptes spp.

According to the disclosure, the formulations control parasitic insects from the group of ectoparasites, such as, ticks, fleas, and sand flies. The compositions, articles of manufacture, formulations and methods of the disclosure are suitable for use in the prophylactic or acute treatment against ectoparasites, in particular against ticks, fleas and sand flies.

Within the context of the present disclosure, the term useful and breeding animals include, for example, cattle, horses, sheep, pigs, goats, camels, water buffalo, donkeys, rabbits, fallow deer, reindeer, fur-bearing animals, such as, for example, mink, chinchilla, raccoon, birds, such as, for example, hens, geese, turkeys, ducks, and the like. According to the disclosure, the term hobby animals and pets, as well as laboratory and test animals include, for example, mice, rats, guinea pigs, golden hamsters, dogs, cats and ferrets.

The disclosure provides methods for controlling insects in the treatment of companion animals such as dogs, cats, and ferrets. Application can take place both prophylactically and therapeutically, or for acute treatment.

According to the disclosure, application takes place by spraying, pouring, dripping or by application via collars for cats or dogs or ferrets. In particular, the use as a spot-on or pour-on formulation as well as the application via active substance in collars are all within the ambit of the methods of application and delivery.

According to the disclosure, the compositions can be formulated in any of the forms that may be useful for the treatment of an infected mammal. Particularly, although not necessarily exclusively, the same may be formulated as solutions, emulsions, soluble powders, insoluble powders, suspensions, ointments, sprays, capsules, tablets, extrusion compositions with palate aids, oral intake compositions and collars. Formulations can be prepared to be applied orally, parenterally, cutaneously (pour-on or spot-on) and as a wearable (e.g., collars). For large animals (for example: bovines, ovines or equines), all formulations are of interest; in case of pets or companion animals (especially cats and dogs) it is also possible to use any composition, but collars are of particular interest.

According to the disclosure, the use of the above-described formulations for the control of parasites, such as, ectoparasites, particularly of ticks, fleas, and sand flies, by application on and treatment of equipment from the keeping of animals, such as, animal baskets, bedding, padding, brushes, cages, stables, and the like is embodied within the disclosure. In this case, the use may also take place both for the prophylactic as well as for the acute treatment.

In certain aspects, when the formulation is used without molding into a shape, the filler and plasticizer is omitted.

In certain aspects, the present disclosure provides, an article of manufacture such as a collar, which includes the active insecticidal compounds, fillers such as thermoplastic resins, and plasticizers, to which other ingredients can be added such as stabilizers, lubricants, or coloring agents.

Fillers such as resins make up about 25% to about 75% w/w, such as about 25% to about 60% w/w of the total formulation; the plasticizer makes up 5% to 60%, such as 10% to 50% weight of the total composition.

Ingredients are admixed and processed by known methods and techniques of dry extrusion of the mixture or molding by injection to produce a molten solid of desired shape, which can in turn be molded in shape, such as a strap or tube, with a buckle, or other releasable fastening device. The strap can have optional holes for the buckle to obtain a collar for cats and dogs to use. As with other types of collars, adjustable attachment means are provided, such as a buckle with corresponding holes, hook and loop fasteners, attachment clips, or any other desired means of attachment.

In certain instances, the disclosure provides a strap or collar that can be wrapped around the neck of an animal. Collars of any suitable length can be easily fabricated depending upon the neck size of the animal. Typically, the collar is selected to be about 6 inches to about 24 inches in length depending upon the neck size of the animal. The ends of the collar can further comprise fastening means. For example, a first end of the collar can comprise a first part, and the second end of the collar can comprise a second part, of a two-part type fastening means, such as a buckle, a snap, a clip, or a hook and loop type fastener or a Velcro® fastener.

In certain aspects, the formulation comprises a filling agent such as a resin such as a plastic resin. The following can be used as resins: polyvinyl resins such as polyvinyl halides (such as polyvinylchloride (PVC)), polymethacrylate esters such as polymethylacrylate and polyethylmethacrylate, polymers of vinyl compounds (such as polystyrene or polyvinylbencene), polyoleofines (such as polypropylene, polyethylene, copolymers of ethylene and propylene), polyvinyl acetals (formed by condensing a polyvinyl alcohol with an aldehyde such as polyvinylbutyral), polyurethanes.

In certain aspects, the plastic resin is a member selected from the group of acrylonitrile butadiene styrene, cellulose nitrate ethylene-vinyl acetate copolymer, polyamide, polybutadiene, polycarbonate, polyethylene, polyethylene terephthalate, polyoxymethylene, polypropylene, polyvinyl acetate, polyvinyl chloride, thermoplastic polyurethane, and thermoplastic rubber.

In certain aspects, the formulation comprises a plasticizer. Suitable plasticizers include, but are not limited to, phosphoric acid esters, such as tricresilphosphate, esters of phthalic acid such as dioctilphtalate or diphenylphtalate, esters of adipic acid, azelaic acid, maleic acid, ricnoleic acid, myristic acid, palmitic acid, oleic acid, sebacic acid, stearic acid, epoxidized soybean oils and polymeric plasticizers.

In certain aspects, the plasticizer is a member selected from the group consisting of dimethyl phthalate, diethyl phthalate, dibutyl phthalate, dihexyl phthalate, di-2-ethyl hexyl phthalate, di-n-octyl phthalate, di-iso-octyl phthalate, di-iso-nonyl phthalate, di-iso-decyl phthalate, di-iso-tridecyl phthalate, dicyclohexyl phthalate, dimethylcyclohexyl phthalate, dimethylglycol phthalate, dibutylglycol phthalate, benzyl butyl phthalate, diphenyl phthalate, tributyl phosphate, tri-2-ethylbutyl phosphate, tri-2-ethylhexyl phosphate, trichloroethyl phosphate, 2-ethylhexyl-di-phenylphosphate, cresyldiphenyl phosphate, triphenyl phosphate, tricresyl phosphate, trixylenyl phosphate, di-2-ethylhexyl adipate, di-iso-octyl adipate, di-iso-nonyl adipate, di-iso-decyl adipate, benzyl butyl adipate, benzyl octyl adipate, di-2-ethylhexyl azelate, di-2-ethylhexyl sebacate, di-iso-decyl sebacate, dioctyl adipate, and mixtures thereof.

Suitable stabilizers are antioxidants and agents which protect resin from ultraviolet radiation and inadequate degradation during extrusion process, such as epoxidized soybean oils (also useful as plasticizer), stearates including stearic acids and polyethylene of low molecular weight. Among antioxidant agents, wherein phenolic antioxidants which hydroxyl group with one or more alkyl groups in positions 2 and/or 4 and/or 6 may be mentioned (such as butylhydroxytoluene, butylhydroxyanisol, and the like).

With this composition, the active compound particles, such as micronized powder may be released permanently on the animal with its natural movements, in this way an extended area of the skin of the animal becomes in contact with the pesticide.

Another possible shape of the molded formulation is as earrings or tags. Earrings may be manufactured from thermoplastic or thermally stable polymeric materials, plasticizers and optionally other materials known in the art, such as coloring agents, lubricants, filling agents, antioxidants, UV stabilizers.

Pesticide concentration may be from 0.5% to 50% w/w, or from 1% to 40% w/w, or in a concentration range from 5% to 20% w/w of the total composition. Thermoplastic material may be used in quantities of 20% to 70%, or from 25% to 60%, or from 45% to 60% of the total composition. The plasticizer may be used in quantities from 1% to 50%, preferably from 5% to 45% weight of the total composition.

The components used for the formulation as earrings resemble those mentioned in the formulation with the shape of a collar and are processed by extrusion techniques and thermal molding well known in the art.

In certain instances, the disclosure provides for the controlled or sustained release of an effective amount of an active ingredient that can protect an animal against ectoparasites such as fleas, ticks, flies, and mites. In certain instances, the release is “sustained” because it occurs continuously over an extended period of time, e.g., for at least 15 days, 30 days, 60 days, 90 days, 120 days, 150 days, or 180 days after manufacture, without interruption. The active ingredients permeate through the collar and is distributed onto the animal's coat by a combination of the chemical nature of the collar, the movement of the device against the animal's coat, and the interaction of the active ingredient and organic solvent with the body oil of the animal.

### II. Examples

### Example 1

Product 1-AA has three active ingredients, which include a neonicotinoid i.e., acetamiprid; a pyrethroid i.e., deltamethrin and an IGR i.e., methoprene. The remaining inactive ingredients are set forth in Table A below.

TABLE A

| Product 1-AA | % w/w |
|---|---|
| Acetamiprid Technical | 10.05 |
| Deltamethrin Technical | 4.06 |
| S-Methoprene Technical | 2.13 |
| Oxyvinyls 240 (PVC) | 42.86 |
| BHT | 0.50 |
| Drapex 6.8 (Epoxidized soybean oil) | 4.50 |
| Dioctyl Adipate | 25.00 |
| Hystrene 5016 (stearic acid) | 0.90 |
| Triphenyl Phosphate | 10.00 |
| Total | 100.00 |

### Example 2

Product 2-BB has three active ingredients, which include a neonicotinoid i.e., dinotefuran; a pyrethroid i.e., deltamethrin and an IGR i.e., methoprene. The remaining inactive ingredients are set forth in Table B below.

TABLE B

| 2-BB | | |
|---|---|---|
| Ingredients | | |
| (Component Name | w/w % | wt (g) |
| Dinotefuran (99.07%) | 10.30 | 515.00 |
| Deltamethrin (99.2%) | 4.13 | 206.50 |
| (s)-Methoprene (98.2%) | 2.05 | 102.50 |
| PVC Resin (OxyVinyl 240) | 37.62 | 1881.00 |
| Drapex 6.8 | 4.50 | 225.00 |
| Dioctyl adipate (DOA) | 20.00 | 1000.00 |
| BHT | 0.50 | 25.00 |
| Stearic acid (Hystrene 5016) | 0.90 | 45.00 |
| Triphenyl phosphate | 20.00 | 1000.00 |
| Total | 100.00 | 5000.00 |

### Example 3

Product 3-CC has two active ingredients, acetamiprid and methoprene.

| Product 3-CC | % w/w |
|---|---|
| Acetamiprid Technical | 10.07 |
| S-Methoprene Technical | 2.13 |
| Oxyvinyls 240 (PVC) | 55.20 |
| BHT | 0.50 |
| Drapex 6.8 (Epoxidized soybean oil) | 3.25 |
| Dioctyl Adipate | 18.00 |
| Hystrene 5016 (stearic acid) | 0.85 |
| Triphenyl Phosphate | 10.00 |
| Total | 100.00 |

### Example 4

This Example provides activity of four insecticidal dog collar vs. a negative control (untreated group), against adult cat flea (Ctenocephalides felis) and American dog ticks (Dermacentor variabilis) in-vivo on dogs.

Test Substance (“TS”) Formulations:

Collar Formulation 1

| Active Ingredient | CAS number | % |
|---|---|---|
| Acetamiprid | 135410-20-7 | 10.0 |
| Deltamethrin | 52918-63-5 | 4.0 |
| (S)-methoprene | 65733-16-6 | 2.0 |
| Inert Ingredients | | 84.0 |
| TOTAL: | | 100.0 |

### Formulations Batch Code: 1-AA-a

Dose form: impregnated plastic matrix dog collar

### Source: Central Garden & Pet Company's Dallas, Tex., USA,

Storage conditions: Ambient conditions (15-30° C.)

Collar Formulation 2

| Active Ingredient | CAS number | % |
|---|---|---|
| Acetamiprid | 135410-20-7 | 10.0 |
| Deltamethrin | 52918-63-5 | 4.0 |
| (S)-methoprene | 65733-16-6 | 2.0 |
| Inert Ingredients | | 84.0 |
| TOTAL: | | 100.0 |

### Formulations Batch Code: 1-AA-b

Dose form: impregnated plastic matrix dog collar

### Source: Central Garden & Pet Company's Dallas, Tex., USA,

Storage conditions: Ambient conditions (15-30° C.)

Collar Formulation 3

| Active Ingredient | CAS number | % |
|---|---|---|
| Acetamiprid | 135410-20-7 | 10.0 |
| Deltamethrin | 52918-63-5 | 4.0 |
| (S)-methoprene | 65733-16-6 | 2.0 |
| Inert Ingredients | | 84.0 |
| TOTAL: | | 100.0 |

### Formulations Batch Code: 1-AA-c

Dose form: impregnated plastic matrix dog collar

### Source: Central Garden & Pet Company's Dallas, Tex., USA,

Storage conditions: Ambient conditions (15-30° C.)

Collar Formulation 4

| Active Ingredient | CAS number | % |
|---|---|---|
| Dinotefuran | 165252-70-0 | 10.0 |
| Deltamethrin | 52918-63-5 | 4.0 |
| (S)-methoprene | 65733-16-6 | 2.0 |
| Inert Ingredients | | 84.0 |
| TOTAL: | | 100.0 |

### Formulations Batch Code: 2-BB-a

Dose form: impregnated plastic matrix dog collar

### Source: Central Garden & Pet Company's Dallas, Tex., USA,

Storage conditions: Ambient conditions (15-30° C.)

Control Substance: None; control dogs are untreated.

### Test System:

Species: domestic dog, Canis lupus familiaris linnaeus
Breed: beagle and beagle cross
Age: >6 months

### Sex: Males and Females

### Initial Weight: 13 to 35 lbs (6 to 16 kg)

Number of Animals: 20 (prequalify 24)

Test System Challenge: The parasites infested per dog for this in-vivo efficacy evaluation were 100 mixed-sex adult cat fleas (Ctenocephalides felis (Bouché), “fleas”) and 50 American dog ticks (Dermacentor variabilis (Say)) for all challenges. The source of fleas were from the AHI resident colony and ticks were obtained from Ecto Services Inc., 166 Crawley Road, Henderson, N.C. 27537.

Animal Housing and Management: Dogs were housed individually in indoor runs, which were cleaned daily. Natural and/or artificial lighting provided 12 hours of light and 12 hours of darkness. Temperature was maintained by the facility HVAC system. Each run was approximately 3×9 ft with welded wire walls and concrete floors. Dogs were grouped by treatment and the different treatment groups were separated by space to allow for adequate separation to prevent cross contamination between groups. During cage cleaning dogs were not sprayed with water or otherwise treated in any manner that impacted test substance residue levels.

Feed and Water: Dogs were fed once daily, approximately 2 cups of commercial dry canine ration. Water was provided ad libitum. No contaminants known to be capable of interfering with the purpose or conduct of this study are reasonably expected to be present in the dietary materials.

Experimental Design: The experiment consisted of five groups of 4 dogs each. Each treatment group was treated with different TS dog collar formulation, and one group served as an untreated Control. All dogs were prequalified via flea challenge to retain at least 50% of infested live fleas at 48 hours. After treatment (day “0”) all dogs were challenged with 100 adult fleas and 50 adult American Dog Ticks biweekly for five months.

Treatment Groups:

| Group No. | Treatment |
|---|---|
| 1 | TS formulation 1 |
| 2 | TS formulation 2 |
| 3 | TS formulation 3 |
| 4 | TS formulation 4 |
| 5 | Untreated control |

Assignment to Treatment: The animals were ranked by flea count in descending order with ties broken by animal ID in descending order. The 20 animals with the highest flea counts and meeting the inclusion criteria were assigned to the treatment groups using the following method: Four blocks of five dogs each were formed from the ranked flea counts comprising the five highest-count dogs, the five next-highest count dogs, and so forth. A lottery system was then used to randomly assign one dog from each of these blocks to each of the five treatment groups.

Animal Health: General observations of health and of adverse reactions for each dog were made and recorded at least once daily and covered the animal's condition from pretreatment to the end of the in-life portion of the study. The absence of health problems were also documented in the raw data. Observations included but were not limited to coat condition, increased salivation, increased or decreased physical activity, any apparent change in eating behavior, any potential signs of adverse reaction to treatment, etc. Observations were recorded on an observation template.

Prequalification of Animals: A minimum of 24 dogs were prequalified according to the following method: On study day −6 each animal being considered for inclusion was infested with 100 adult fleas. Fleas were infested on the dorsal midline with the dog restrained by hand for sufficient time for the fleas to disperse into the animal's coat.

Approximately 48 hours post infestation the entire body of each of the 24 animals was combed and fleas were be accumulated in a flea holding container. The comb was examined as fleas are placed in the flea holding container and for each dog the numbers of live and dead fleas were recorded separately on a Flea Count data sheet. Immediately after collecting, the flea holding container was misted with isopropyl alcohol and fleas were enumerated by dumping the container contents onto a white background.

The candidate dogs were ranked by flea count, and the top 20 animals retaining at least 50 (live) of the 100 fleas infested were used to stock the five treatment groups of four dogs each.

Treatment: Test Substance Collar Formulations: On Treatment Day 0 all animals in Test Substance Groups 1, 2, 3 and 4 were treated by applying their respective Test Substance collars via the following procedures: Collars were attached around the appropriate dog's neck. The collar was secured snug enough to prevent dog's leg or jaw from getting caught in the collar.

Control Group The control group remained untreated.

Flea & Tick Challenges: The data from all replicates within each treatment group were combined for each data point. Percent mortality of adult fleas and ticks were separately calculated using Abbott's formula (Abbott, W. S. 1925. J. Econ. Ent. 18: 265-267) to correct for natural mortality in the Control group.

Infestations on Days 12, 26, and at 14-day intervals thereafter (e.g. days 40, 54, etc.) all dogs in all groups remaining on test were infested with 100 adult fleas and 50 adult American dog ticks. Infestations were made along the dorsal midline of the animal while restraining the animal. Infestations were made a minimum of 10 cm from any TS collar.

Flea counts: Flea counts were taken approximately 48 hours after infestations with the data recorded on a Flea Count Data sheet.

Tick Counts: Tick counts were taken concurrent to the flea counts. Each dog was examined for the presence of live, dead, and moribund, free and attached ticks, and counts of those ticks in each category were recorded on a Tick Count Data sheet. “Tick attachment” was defined as the condition in which a tick has its mouthparts inserted into the skin of the host dog; this is normally accompanied by the tick secreting a cement at the attachment site that renders removal of the tick more difficult. These counts were accomplished by examining each animal in a methodical manner beginning at the head and proceeding to the tail examining the entire body. The examination was visual, tactile, and mechanical. Each animal was thoroughly examined by massaging the entire body with the hands while viewing any bumps that are found. Then that animal was examined mechanically by combing close to the skin with a fine toothed flea comb to catch any ticks that were missed in the visual/tactile examination. As ticks are located they were removed, identified as attached vs. unattached, and live vs. dead.

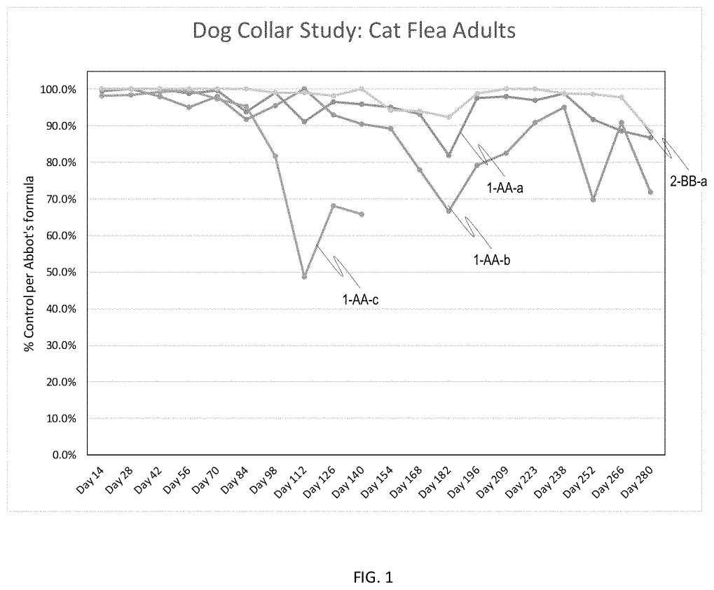

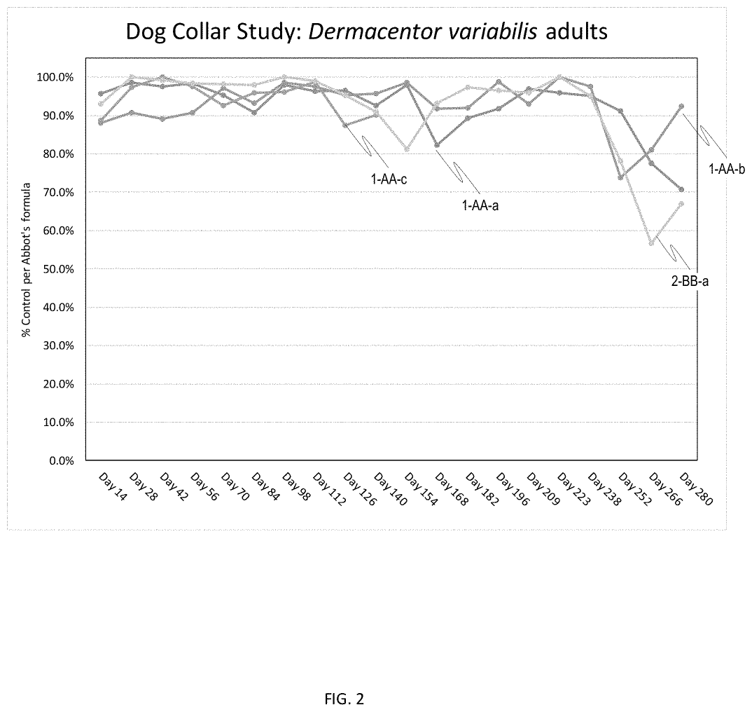

FIG. 1 and FIG. 2 show percent control by treatment and day post-treatment for fleas and ticks, respectively. All the collars with effective. As the data indicates, Formulation 4 (2-BBa) showed the greatest efficacy during the 280 day evaluation followed very closely by Formulation 1 (1-AAa) and then followed by Formulation 3 (1-AAc). Formulation 3 (1-AAc) showed good efficacy, as did Formulation 2 (1-AAb).

Formulation 4 showed ≥92% efficacy through Day 266 of the evaluation when control fell to 88% on Day 280, the final count day of the trial. Similarly, Formulation 1 showed ≥92% efficacy during the trial except for a few counts. Formulation 2 showed ≥90% efficacy.

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references cited in this application, including patent applications, patents, and PCT publications, are incorporated herein by reference for all purposes.

What is claimed is:

1. An insecticide formulation, the formulation comprising:
i) a neonicotinoid optionally together with a pyrethroid;
ii) an insect growth regulator; and
iii) a filling agent together with a plasticizer.

2. The insecticide formulation of claim 1, wherein the neonicotinoid is a member selected from the group consisting of acetamiprid, clothianidin, dinotefuran, imidacloprid, nitenpyram, thiocloprid, thiamethoxam and mixtures thereof.

3. The insecticide formulation of claim 1, wherein the neonicotinoid is acetamiprid.

4. The insecticide formulation of claim 1, wherein the neonicotinoid is dinotefuran.

5. The insecticide formulation of claim 1, wherein the pyrethroid is present and is a member selected from the group consisting of allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, lambda-cyhalothrin, metofluthrin, permethrin, prallethrin, pyrethrin I, cinerin I, jasmolin I, pyrethrin II, cinerin II, jasmolin II, resmethrin, silafluofen, sumithrin, tau-fluvalinate, tefluthrin, tetramethrin, tralomethrin, and transfluthrin.

6. The insecticide formulation of claim 5, wherein the pyrethroid is deltamethrin.

7. The insecticide formulation of claim 1, wherein the insect growth regulator is a member selected from the group consisting of diflubenzuron, azadirachtin, hydroprene, methoprene, pyriproxyfen and triflumuron.

8. The insecticide formulation of claim 1, wherein the formulation further comprises a lubricant.

9. The insecticide formulation of claim 8, wherein the lubricant is a member selected from the group consisting of a paraffin oil, a polyethylene wax, a long chain fatty alcohol, a distearyl ketone, a long chain fatty acid, metal salts thereof and esters thereof.

10. The insecticide formulation of claim 1, wherein the formulation further comprises a preservative.

11. The insecticide formulation of claim 10, wherein the preservative is a member selected from the group consisting of 2-(2H-Benzotriazol-2-yl)-4-methylphenol, 2-Ethylhexyl 2-cyano-3,3-diphenylacrylate, α-tocopherol, bis(1,2,2,6,6-pentamethyl-4-piperidinyl) decanedioate, bis-(2,4-ditertbutylphenyl)-pentaerythrityl-diphosphite, bisphenol A, butylated hydroxytoluene, butylated hydroxyanisole, dilauryl thiopropionate, distearyl thiodipropionate, dioctadecyl disulfide, epoxidized soybean oil, epoxidized linseed oil, epozidized tall oil esters, pentaerythritol tetrakis(3,5-di-tert-butyl-4-hydroxyhydrocinnamate), zinc 2-pyridinethiol-1-oxide, tetrakis-(2,4-ditertbutylphenyl)-4,4′-diphenylylenediphosphonite, distearyl-petaerythrityl-diphosphite, tris-(nonylphenyl)-phosphite, and tris-(2,4-ditertbutylphenyl)-phosphite.

12. The insecticide formulation of claim 1, wherein the filling agent is a plastic resin.

13. The insecticide formulation of claim 12, wherein the plastic resin is a member selected from the group consisting acrylonitrile butadiene styrene, cellulose nitrate ethylene-vinyl acetate copolymer, polyamide, polybutadiene, polycarbonate, polyethylene, polyethylene terephthalate, polyoxymethylene, polypropylene, polyvinyl acetate, polyvinyl chloride, thermoplastic polyurethane, and thermoplastic rubber.

14. The insecticide formulation of claim 1, wherein the plasticizer is a member selected from the group consisting of dimethyl phthalate, diethyl phthalate, dibutyl phthalate, dihexyl phthalate, di-2-ethyl hexyl phthalate, di-n-octyl phthalate, di-iso-octyl phthalate, di-iso-nonyl phthalate, di-iso-decyl phthalate, di-iso-tridecyl phthalate, dicyclohexyl phthalate, dimethylcyclohexyl phthalate, dimethylglycol phthalate, dibutylglycol phthalate, benzyl butyl phthalate, diphenyl phthalate, tributyl phosphate, tri-2-ethylbutyl phosphate, tri-2-ethylhexyl phosphate, trichloroethyl phosphate, 2-ethylhexyl-di-phenylphosphate, cresyldiphenyl phosphate, triphenyl phosphate, tricresyl phosphate, trixylenyl phosphate, di-2-ethylhexyl adipate, di-iso-octyl adipate, di-iso-nonyl adipate, di-iso-decyl adipate, benzyl butyl adipate, benzyl octyl adipate, di-2-ethylhexyl azelate, di-2-ethylhexyl sebacate, di-iso-decyl sebacate, dioctyl adipate, and mixtures thereof.

15. The insecticide formulation of claim 1, wherein the neonicotinoid is present at about 5% to about 15% w/w.

16. The insecticide formulation of claim 1, wherein the insect growth regulator is present at about 0.5% to about 5% w/w.

17. The insecticide formulation of claim 1, wherein the pyrethroid is present at about 0.5% to about 10% w/w.

18. A method for controlling insects on a companion animal, the method comprising:
contacting the companion animal with an insecticide composition comprising:
i) a neonicotinoid optionally together with a pyrethroid;
ii) an insect growth regulator; and
iii) a filling agent together with a plasticizer, to thereby treat the companion animal.

19. The method of claim 18, wherein the neonicotinoid is a member selected from the group consisting of acetamiprid, clothianidin, and dinotefuran, imidacloprid, nitenpyram, thiocloprid, thiamethoxam and mixtures thereof.

20. The method of claim 18, wherein the neonicotinoid is dinotefuran.
